(19) United States
(12) Patent Application Publication
(10) Pub. No.: US 2014/0306856 A1
(43) Pub. Date: Oct. 16, 2014

(54) Antenna and Mobile Terminal

(71) Applicant: Huawei Device Co., Ltd., Shenzhen (CN)

(72) Inventors: Yi Fan, Shenzhen (CN); Lina Chen, Shenzhen (CN); Yao Lan, Shenzhen (CN); Shuhui Sun, Shenzhen (CN)

(21) Appl. No.: 14/314,406

(22) Filed: Jun. 25, 2014

Related U.S. Application Data
(63) Continuation of application No. PCT/CN2013/071170, filed on Jan. 31, 2013.

(30) Foreign Application Priority Data
Feb. 16, 2012 (CN) 201220050433.4

(51) Int. Cl. H01Q 1/50; H01Q 9/04

(52) U.S. Cl. CPC H01Q 1/50; H01Q 9/04
USPC 343/749

(57) ABSTRACT

An antenna and a mobile terminal are disclosed that relate to the communications field. The antenna includes a ground cable and a feeder, where the feeder includes a low-frequency branch and a high-frequency branch; the low-frequency branch and the high-frequency branch have a common endpoint; the low-frequency branch is surrounded by the ground cable to form a coupled loading mode and an equivalent coupled feed loop antenna radiation mode; and the high-frequency branch is set outside the ground cable to complete a high-frequency monopole radiation mode. The mobile terminal includes a printed circuit board (PCB) and the antenna, and the antenna is printed on the PCB. An embodiment of the present invention resolves a problem of insufficient low-frequency bandwidth and insufficient high-frequency bandwidth in the prior art, effectively improves performance of the antenna, and can effectively disperse near-field energy to the PCB and the mobile terminal.

### CROSS-REFERENCE TO RELATED APPLICATIONS

This application is a continuation of International Application No. PCT/CN2013/071170, filed on Jan. 31, 2013, which claims priority to Chinese Patent Application No. 201220050433.4, filed on Feb. 16, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the communications field, and in particular, to an antenna and a mobile terminal.

### BACKGROUND

A mobile terminal (also called a mobile communications terminal) refers to a computer device that can be used in motion. Broadly speaking, the mobile terminal includes a mobile phone, a notebook computer, a point of sale (POS) machine, or even a vehicle-mounted computer. However, in most cases, the mobile terminal refers to the mobile phone or a smartphone with a plurality of application functions.

The mobile phone is used as an example in the following descriptions. The mobile phone generally includes an antenna, where the antenna generally uses a planar inverted F antenna (PIFA) or a monopole antenna. The foregoing antennas are basically the same in structure, and they both include a ground cable and a feeder.

However, due to limitations of the foregoing antenna structure, there is a problem of insufficient low-frequency bandwidth and insufficient high-frequency bandwidth, which affects performance of the antennas.

In addition, an antenna in the prior art also has a problem that a working frequency is limited by dimensions of a terminal, which affects performance of the antenna.

### SUMMARY

Embodiments of the present invention provides an antenna and a mobile terminal so as to overcome a problem of insufficient low-frequency bandwidth and insufficient high-frequency bandwidth that exist in an antenna in the prior art. Technical solutions are as follows:

An antenna, including a ground cable and a feeder, where the feeder includes a low-frequency branch and a high-frequency branch, and the low-frequency branch and the high-frequency branch have a common endpoint; where: the low-frequency branch is surrounded by the ground cable, a gap is set between the low-frequency branch and the ground cable, and the low-frequency branch and the ground cable form a coupled loading mode and an equivalent coupled feed loop antenna radiation mode; and the high-frequency branch is set outside the ground cable to complete a high-frequency monopole radiation mode.

An embodiment of the present invention further provides a mobile terminal, including a printed circuit board (PCB) and further including the antenna, where the antenna is printed on the PCB.

The technical solutions according to the embodiments of the present invention have the following beneficial effects: compared with the prior art, the embodiments of the present invention complete the high-frequency monopole radiation mode by setting the high-frequency branch outside the ground cable, and form the coupled loading mode and the equivalent coupled feed loop antenna radiation mode by surrounding the low-frequency branch with the ground cable. As a result, the problem of insufficient low-frequency bandwidth and insufficient high-frequency bandwidth that exists in the antenna in the prior art is resolved, and performance of the antenna is effectively improved; furthermore, by printing the antenna on the PCB, near-field energy is effectively dispersed to the PCB and the mobile terminal, so as to achieve an objective of reducing a specific absorption rate (SAR); then, by printing the antenna of the present invention on the PCB, cost is reduced and an effective distance from the antenna to an SAR test instrument trunk model is increased; and in addition, because the antenna of the present invention can be flexibly arranged on the PCB, the problem in the prior art that a working frequency is limited by dimensions of a terminal is resolved, thereby effectively improving performance of the antenna.

### BRIEF DESCRIPTION OF THE DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic diagram of an overall structure of an antenna according to an embodiment of the present invention;

FIG. 2 is a schematic structural diagram of an antenna applied on a PCB according to an embodiment of the present invention;

FIG. 3 is an operating mode diagram of an antenna according to an embodiment of the present invention; and

FIG. 4 is an efficiency diagram of an antenna according to an embodiment of the present invention.

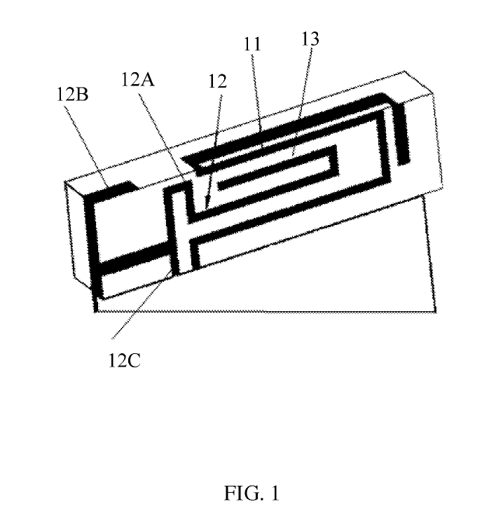

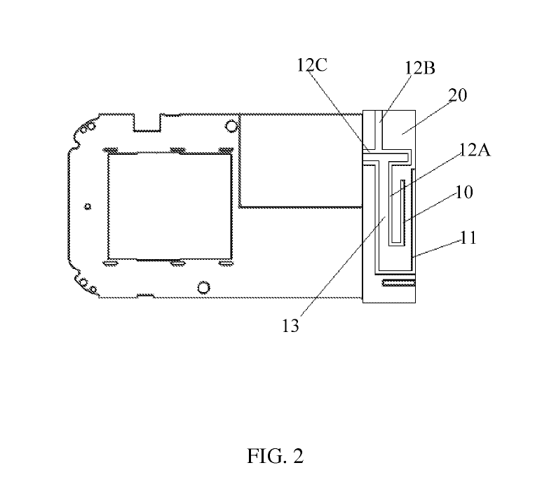

Description of reference numerals in FIG. 1 to FIG. 2 is as follows: 10: antenna, 11: ground cable, 12: feeder, 12A: low-frequency branch, 12B: high-frequency branch, 12C: common endpoint, 13: gap, and 20: PCB.

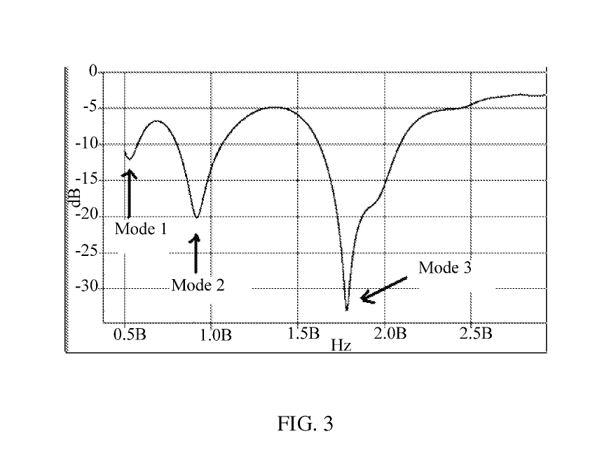

In FIG. 3, a horizontal coordinate represents a frequency in the unit of hertz (Hz); a vertical coordinate represents return loss in the unit of decibel (db); mode 1 represents an equivalent coupled feed loop antenna radiation mode; mode 2 represents a coupled loading mode; and mode 3 represents a high-frequency monopole radiation mode.

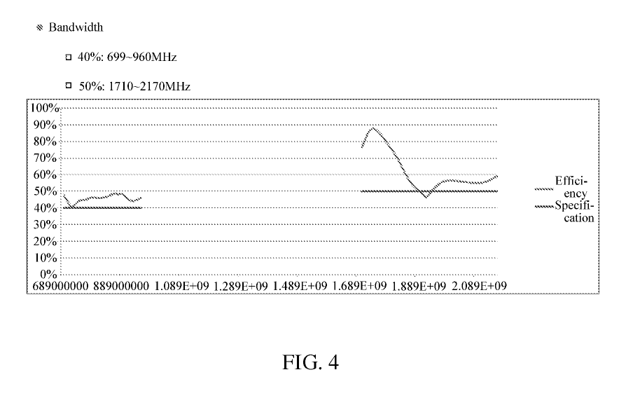

In FIG. 4, a horizontal coordinate represents a frequency in the unit of Hz; a vertical coordinate represents an efficiency in the unit of percentage (%).

### DETAILED DESCRIPTION

To make the objectives, technical solutions, and advantages of the present invention clearer, the following further describes in detail the implementation manners of the present invention with reference to the accompanying drawings.

### Embodiment 1

As shown in FIG. 1, an antenna of the present invention includes a ground cable 11 and a feeder 12, where the feeder 12 includes a low-frequency branch 12A and a high-frequency branch 12B, and the low-frequency branch 12A and the high-frequency branch 12B have a common endpoint 12C.

The low-frequency branch 12A is surrounded by the ground cable 11; a gap 13 is set between the low-frequency branch 12A and the ground cable 11; and the low-frequency branch 12A and the ground cable 11 form a coupled loading mode and an equivalent coupled feed loop antenna radiation mode.

Specifically, because the ground cable 11 is close to the low-frequency branch 12A, the low-frequency branch 12A and the ground cable 11 form a capacitor; whereas a high-frequency signal on the low-frequency branch 12A may be coupled to the ground cable 11 from the low-frequency branch 12A by using the capacitor, where the low-frequency branch 12A itself is the antenna. Therefore, as shown in FIG. 1, the capacitor is coupled onto the antenna, which is called capacitive loading, that is, the low-frequency branch 12A and the ground cable 11 form the coupled loading mode.

Specifically, because the low-frequency branch 12A and the ground cable 11 are coupled to form the capacitor, the high-frequency signal passes through the capacitor. Although the low-frequency branch 12A and the ground cable 11 are not physically (or substantially) connected, they are in fact connected for the high-frequency signal, which is equivalent to a channel. Specifically, an equivalent closed-loop electric structure is formed from the low-frequency branch 12A to a PCB via the ground cable 11, that is, the low-frequency branch 12A and the ground cable 11 form the equivalent coupled feed loop antenna radiation mode.

The high-frequency branch 12B is set outside the ground cable 11 so as to complete a high-frequency monopole radiation mode.

Compared with the prior art, as shown in FIG. 1, this embodiment of the present invention completes the high-frequency monopole radiation mode (refer to mode 3 in FIG. 3) by setting the high-frequency branch 12B outside the ground wire 11, and forms the coupled loading mode (refer to mode 1 in FIG. 3) and the equivalent coupled feed loop antenna radiation mode (refer to mode 2 in FIG. 3) by surrounding the low-frequency branch 12A with the ground cable 11. At the same time, the low-frequency branch 12A expands high-frequency bandwidth by using such radiation modes as frequency multiplication and the gap 13 between the low-frequency branch 12A and the ground cable 11. Therefore, the antenna of the present invention resolves the problem of insufficient low-frequency bandwidth and insufficient high-frequency bandwidth that exists in the antenna in the prior art, thereby effectively improving performance of the antenna.

Specifically, as shown in FIG. 1, preferably, a part of the low-frequency branch 12A is surrounded by the ground cable 11.

Specifically, as shown in FIG. 1, preferably, the ground cable 11 is a serpentine wire.

Specifically and preferably, the ground cable 11 mainly controls an antenna standing wave at 700 Megahertz (MHz) to 740 MHz.

Specifically and preferably, the low-frequency branch 12A controls a bandwidth standing wave near 900 MHz.

Specifically and preferably, the high-frequency branch 12B controls a high-frequency standing wave so as to complete coverage of the high-frequency bandwidth in conjunction with the low-frequency branch 12A and the ground cable 11.

By using the foregoing preferred frequencies, an antenna on a mobile terminal can meet a Long Term Evolution (LTE) frequency band requirement, for example, frequency bands of 699-960 MHz, 1710-2170 MHz, and a low-frequency bandwidth of about 270 MHz required by the AT&T, a mobile operator in the United States (U.S.), thereby resolving a problem that a traditional antenna cannot complete coverage of the foregoing frequency bands.

### Embodiment 2

As shown in FIG. 2, this embodiment of the present invention further provides a mobile terminal, including a PCB 20 and further including an antenna 10, where the antenna 10 is printed on the PCB 20. A structure of the antenna 10 is the same as that of the antenna described in Embodiment 1, so details on the structure of the antenna 10 are not described again in this embodiment.

Compared with the prior art, the antenna of the present invention effectively integrates a plurality of antenna radiation modes, including three radiation modes: an equivalent coupled feed loop antenna radiation mode, a coupled loading mode, and a high-frequency monopole radiation mode, thereby resolving the problem of insufficient low-frequency bandwidth and insufficient high-frequency bandwidth that exists in the antenna in the prior art, and effectively improving performance of the antenna; in addition, by printing the antenna on the PCB, near-field energy is effectively dispersed to the PCB and the mobile terminal, so as to achieve an objective of reducing an SAR; furthermore, by printing the antenna of the present invention on the PCB, cost is reduced and an effective distance from the antenna to an SAR test instrument trunk model is increased; in addition, because the antenna of the present invention can be flexibly arranged on the PCB, the problem in the prior art that a working frequency is limited by dimensions of a terminal is resolved, and the performance of the antenna is effectively improved (as shown in FIG. 4).

The foregoing descriptions are merely new exemplary embodiments of the present invention, but are not intended to limit the present invention. Any modification, equivalent replacement, and improvement made without departing from the spirit and principle of the present invention shall fall within the protection scope of the present invention.

What is claimed is:

1. An antenna, comprising:
a ground cable; and
a feeder,
wherein the feeder comprises a low-frequency branch and a high-frequency branch, and the low-frequency branch and the high-frequency branch have a common endpoint,
wherein the low-frequency branch is surrounded by the ground cable, a gap is set between the low-frequency branch and the ground cable, and the low-frequency branch and the ground cable form a coupled loading mode and an equivalent coupled feed loop antenna radiation mode, and
wherein the high-frequency branch is set outside the ground cable to complete a high-frequency monopole radiation mode.

2. The antenna according to claim 1, wherein the ground cable is a serpentine wire.

3. The antenna according to claim 1, wherein the ground cable mainly controls a bandwidth of an antenna standing wave at 700 Megahertz (MHz) to 740 MHz.

4. The antenna according to claim 2, wherein the ground cable mainly controls a bandwidth of an antenna standing wave at 700 Megahertz (MHz) to 740 MHz.

5. The antenna according to claim 3, wherein the low-frequency branch controls a bandwidth of a bandwidth standing wave near 900 MHz.

6. The antenna according to claim 4, wherein the low-frequency branch controls a bandwidth of a bandwidth standing wave near 900 MHz.

7. The antenna according to claim 5, wherein the high-frequency branch controls a bandwidth of a high-frequency standing wave to complete coverage of high-frequency bandwidth in conjunction with the low-frequency branch and the ground cable.

8. The antenna according to claim 6, wherein the high-frequency branch controls a bandwidth of a high-frequency standing wave to complete coverage of high-frequency bandwidth in conjunction with the low-frequency branch and the ground cable.

9. A mobile terminal, comprising:
a printed circuit board; and
an antenna,
wherein the antenna is printed on the printed circuit board, and
wherein the antenna comprises:
a ground cable; and
a feeder,
wherein the feeder comprises a low-frequency branch and a high-frequency branch, and the low-frequency branch and the high-frequency branch have a common endpoint,
wherein the low-frequency branch is surrounded by the ground cable, a gap is set between the low-frequency branch and the ground cable, and the low-frequency branch and the ground cable form a coupled loading mode and an equivalent coupled feed loop antenna radiation mode, and
wherein the high-frequency branch is set outside the ground cable to complete a high-frequency monopole radiation mode.

10. The mobile terminal according to claim 9, wherein the ground cable is a serpentine wire.

11. The mobile terminal according to claim 9, wherein the ground cable mainly controls a bandwidth of an antenna standing wave at 700 Megahertz (MHz) to 740 MHz.

12. The mobile terminal according to claim 10, wherein the ground cable mainly controls a bandwidth of an antenna standing wave at 700 Megahertz (MHz) to 740 MHz.

13. The mobile terminal according to claim 11, wherein the low-frequency branch controls a bandwidth of a bandwidth standing wave near 900 MHz.

14. The mobile terminal according to claim 12, wherein the low-frequency branch controls a bandwidth of a bandwidth standing wave near 900 MHz.

15. The mobile terminal according to claim 13, wherein the high-frequency branch controls a bandwidth of a high-frequency standing wave to complete coverage of high-frequency bandwidth in conjunction with the low-frequency branch and the ground cable.

16. The mobile terminal according to claim 14, wherein the high-frequency branch controls a bandwidth of a high-frequency standing wave to complete coverage of high-frequency bandwidth in conjunction with the low-frequency branch and the ground cable.
